(19) United States
(12) Patent Application Publication
(10) Pub. No.: US 2024/0421836 A1
(43) Pub. Date: Dec. 19, 2024

(54) RADIO-FREQUENCY CIRCUIT

(71) Applicant: Murata Manufacturing Co., Ltd., Nagaokakyo-shi (JP)

(72) Inventors: Morio TAKEUCHI, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 18/822,495

(22) Filed: Sep. 3, 2024

Related U.S. Application Data
(63) Continuation of application No. PCT/JP2023/005062, filed on Feb. 14, 2023.

(30) Foreign Application Priority Data
Mar. 9, 2022 (JP) 2022-036636

(51) Int. Cl. H04B 1/00; H04B 1/04; H04B 1/16

(52) U.S. Cl. CPC H04B 1/0078; H04B 1/04; H04B 1/16; H04B 2001/0408

(57) ABSTRACT

A radio-frequency circuit includes first and second transfer circuits. The first transfer circuit supports reception of a cellular communication system and a satellite system. The second transfer circuit supports transmission and reception of the cellular communication system. The first transfer circuit includes a first filter circuit and a first low-noise amplifier circuit. The first filter circuit is connected to a first antenna connection terminal and has a pass band including a cellular receive band and a satellite receive band. The first low-noise amplifier circuit is connected to the first filter circuit. The second transfer circuit includes a second filter circuit, a power amplifier circuit, and a second low-noise amplifier circuit. The second filter circuit is connected to a second antenna connection terminal and has a pass band including the cellular receive band and a cellular transmit band corresponding to the cellular receive band.

### CROSS-REFERENCE TO RELATED APPLICATIONS

This is a continuation application of PCT International Application No. PCT/JP2023/005062 filed on Feb. 14, 2023, designating the United States of America, which is based on and claims priority of Japanese Patent Application No. 2022-036636 filed on Mar. 9, 2022. The entire disclosures of the above-identified applications, including the specifications, drawings, and claims are incorporated herein by reference in their entirety.

### BACKGROUND OF THE DISCLOSURE

### 1. Field of the Disclosure

The present disclosure relates to a radio-frequency circuit.

### 2. Description of the Related Art

In mobile communication equipment, such as mobile phones, the configuration of a radio-frequency front-end module is becoming complicated in accordance with the widespread use of multiple bands (see U.S. Patent Application Publication No. 2015/0065124 and Japanese Unexamined Patent Application Publication (Translation of PCT Application) No. 2017-527155, for example).

### SUMMARY OF THE DISCLOSURE

With the technologies of the above-described related art, the size of a communication device may be increased.

The present disclosure provides a radio-frequency circuit that can contribute to reducing the size of a communication device.

A radio-frequency circuit according to an aspect of the disclosure includes first and second transfer circuits. The first transfer circuit supports reception of a cellular communication system and a satellite system. The second transfer circuit supports transmission and reception of the cellular communication system. The first transfer circuit includes a first filter circuit and a first low-noise amplifier circuit. The first filter circuit is connected to a first antenna connection terminal and has a pass band including a cellular receive band and a satellite receive band. The first low-noise amplifier circuit is connected to the first filter circuit. The second transfer circuit includes a second filter circuit, a power amplifier circuit, and a second low-noise amplifier circuit. The second filter circuit is connected to a second antenna connection terminal and has a pass band including the cellular receive band and a cellular transmit band corresponding to the cellular receive band. The power amplifier circuit is connected to the second filter circuit. The second low-noise amplifier circuit is connected to the second filter circuit. The first transfer circuit includes one or more receive paths through which a reception signal input via the first antenna connection terminal is transferred. The first transfer circuit does not include a transmit path through which a transmission signal to be output via the first antenna connection terminal is transferred.

Using a radio-frequency circuit according to an aspect of the disclosure makes it possible to contribute to reducing the size of a communication device.

These and other objects, advantages and features of the disclosure will become apparent from the following description thereof taken in conjunction with the accompanying drawings that illustrate specific embodiments of the present disclosure. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a circuit diagram of a communication device according to a first embodiment;

FIG. 2 is a plan view of a first radio-frequency module according to a first example of the first embodiment;

FIG. 3 is a partial sectional view of the first radio-frequency module according to the first example of the first embodiment;

FIG. 4 is a plan view of a second radio-frequency module according to the first example of the first embodiment;

FIG. 5 is a plan view of a radio-frequency module according to a second example of the first embodiment;

FIG. 6 is a circuit diagram of a communication device according to a second embodiment;

FIG. 7 is a circuit diagram of a communication device according to a third embodiment;

FIG. 8 is a circuit diagram of a communication device according to a modified example of the third embodiment;

FIG. 9 is a circuit diagram of a communication device according to a fourth embodiment; and

FIG. 10 is a circuit diagram of a communication device according to a fifth embodiment.

### DESCRIPTION OF THE PREFERRED EMBODIMENTS

### (Underlying Knowledge Forming Basis of Disclosure)

Lately, it is desired that mobile communication devices support a satellite system as well as a cellular communication system. For example, U.S. Patent Application Publication No. 2015/0065124 discloses a communication device including a module for receiving a satellite system signal such as a GPS (Global Positioning System) signal (hereinafter called a satellite signal), as well as a module for transmitting and receiving a cellular communication system signal (hereinafter called a cellular signal).

Using multiple antennas in a mobile communication device may improve the communication performance, such as the quality, reliability, and capability of communication. For instance, Japanese Unexamined Patent Application Publication (Translation of PCT Application) No. 2017-527155 discloses a communication device including a transmit/receive module for transmitting and receiving a signal using a primary antenna and a receive module for receiving a signal using a diversity antenna.

In the above-described related art, however, to transmit and receive cellular signals and to receive satellite signals using multiple antennas, more modules may be required, which may increase the size of a communication device.

To address this issue, a radio-frequency circuit that can contribute to reducing the size of a communication device which supports transmission/reception of cellular signals and reception of satellite signals by using multiple antennas will be described below in detail through illustration of embodiments. The embodiments described below illustrate general or specific examples. Numerical values, shapes, materials, elements, and positions and connection states of the elements illustrated in the following embodiments are only examples and are not intended to limit the disclosure.

The drawings are only schematically shown and are not necessarily precisely illustrated. For the sake of representation, the drawings may be illustrated in an exaggerated manner or with omissions and the ratios of elements in the drawings may be adjusted. The shapes, positional relationships, and ratios of elements in the drawings may be different from those of the actual elements. In the drawings, substantially identical elements are designated by like reference numeral, and an explanation of such elements may be omitted or be merely simplified from the second time onwards.

In the individual drawings, the x axis and the y axis are axes which are perpendicular to each other on a plane parallel with a main surface of a module laminate. More specifically, assuming the module laminate has a rectangular shape in a plan view, the x axis is parallel with a first side of the module laminate, while the y axis is parallel with a second side of the module laminate, which is perpendicular to the first side. The z axis is an axis perpendicular to the main surface of the module laminate. The positive direction of the z axis is the upward direction, while the negative direction of the z axis is the downward direction.

In the circuit configurations of the disclosure, “A is connected to B” includes, not only the meaning that A is directly connected to B using a connection terminal and/or a wiring conductor, but also the meaning that A is electrically connected to B via another circuit element. “An element is connected between A and B” means that the element is connected to both A and B between A and B and includes the meaning that the element is connected in series with a path connecting A and B and also that the element is parallel-connected (shunt-connected) between this path and a ground.

In the arrangement of components in the disclosure, “a component is disposed in or on a substrate or a module laminate” includes the meaning that the component is disposed on a main surface of the substrate or the module laminate and the meaning that the component is disposed in the substrate or the module laminate. “A component is disposed on a main surface of a substrate or a module laminate” includes the meaning that the component is disposed on a main surface of the substrate or the module laminate while being in contact with the main surface, and also includes the meaning that the component is disposed over the main surface without contacting it (for example, the component is placed on another component which is in contact with the main surface). “A component is disposed on a main surface of a substrate or a module laminate” may include the meaning that the component is disposed in a recessed portion formed on the main surface. “A component is disposed in a substrate or a module laminate” may include the meaning that the component is capsulated within the substrate or the module laminate and also the meaning that the entirety of the component is disposed between the main surfaces of the substrate or the module laminate, but part of the component is not covered with the substrate or the module laminate, and the meaning that only part of the component is disposed in the substrate or the module laminate.

In the communication system in an embodiment of the disclosure, “cellular receive band” is a frequency band used for a cellular communication system and used for the reception in a communication device. “Cellular transmit band” is a frequency band used for a cellular communication system and used for the transmission in a communication device. “Satellite receive band” is a frequency band used for a satellite system and used for reception in a communication device. “Satellite transmit band” is a frequency band used for a satellite system and used for transmission in a communication device.

“Cellular communication system” is a communication system standardized by a standardizing body (such as 3GPP (registered trademark) (3rd Generation Partnership Project) and IEEE (Institute of Electrical and Electronics Engineers)) for a cellular network. The cellular communication system includes a non-terrestrial network (NTN) as well as a terrestrial network (TN). The NTN is a network standardized by 3GPP to integrate a satellite system, for example, to the cellular communication system. In the following embodiments, as the cellular communication system, an LTE (Long Term Evolution) communication system and/or a 5GNR (5th Generation New Radio) communication system are used. However, the cellular communication system is not limited to these types of systems. For example, a 6th or subsequent generation cellular communication system may be used.

“Satellite system” is a system using an artificial satellite. In the following embodiments, as the satellite system, a satellite navigation system and/or a satellite communication system are used. However, the satellite system is not limited to these types of systems. The satellite communication system includes the NTN, but does not include the TN.

In the disclosure, terms representing the relationship between elements, such as “being parallel” and “being vertical”, terms representing the shape of an element, such as “being rectangular”, and a range of numerical values are not necessarily to be interpreted in an exact sense, but to be interpreted in a broad sense. That is, such terms also cover substantially equivalent ranges, such as about several percent of allowance.

### First Embodiment

A first embodiment will be described below. In the first embodiment, as the cellular transmit band and the cellular receive band, the uplink operating band and the downlink operating band included in the same FDD (Frequency Division Duplex) band are used.

### [1.1 Circuit Configuration of Communication Device 5]

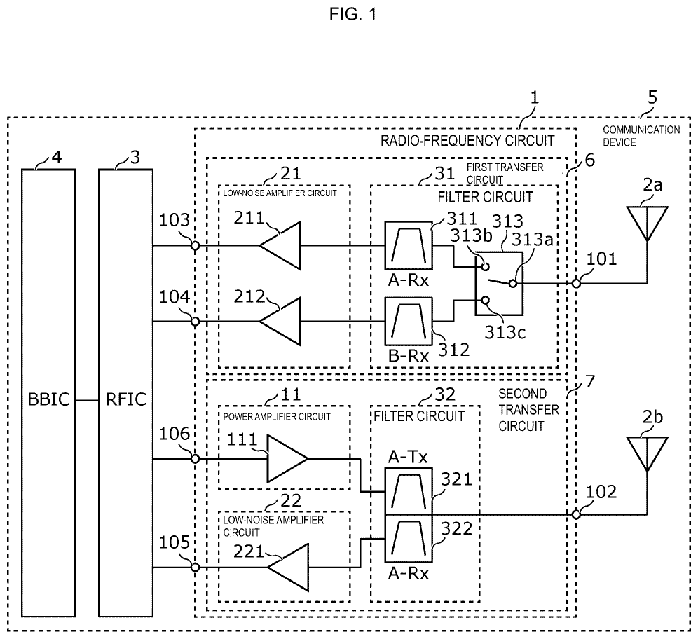

First, the circuit configuration of a communication device 5 according to the first embodiment will be described below with reference to FIG. 1. FIG. 1 is a circuit diagram of the communication device 5 according to the first embodiment.

The communication device 5 corresponds to UE (User Equipment) in the cellular communication system and is typically a mobile phone, a smartphone, a tablet computer, or a wearable device, for example. The communication device 5 may be an IoT (Internet of Things) sensor device, a medical/healthcare device, a vehicle, an unmanned aerial vehicle (UAV) (known as a drone), or an automated guided vehicle (AGV). The communication device 5 may serve as a base station (BS) in the cellular communication system.

As illustrated in FIG. 1, the communication device 5 includes a radio-frequency circuit 1, antennas 2a and 2b, a radio frequency integrated circuit (RFIC) 3, and a baseband integrated circuit (BBIC) 4.

The radio-frequency circuit 1 can transfer a radio-frequency signal between each of the antennas 2a and 2b and the RFIC 3. The radio-frequency circuit 1 includes a first transfer circuit 6 and a second transfer circuit 7. The first transfer circuit 6 supports the reception of the cellular communication system and the reception of the satellite system. The second transfer circuit 7 supports the transmission and reception of the cellular communication system. Details of the internal configuration of the radio-frequency circuit 1 will be discussed later.

The antenna 2a is an example of a diversity antenna and is connected to an antenna connection terminal 101 of the radio-frequency circuit 1. The antenna 2a can receive a radio-frequency signal from the outside and supply the received radio-frequency signal to the radio-frequency circuit 1.

The antenna 2b is an example of a primary antenna and is connected to an antenna connection terminal 102 of the radio-frequency circuit 1. The antenna 2b can receive a radio-frequency signal from the outside and supply the received radio-frequency signal to the radio-frequency circuit 1. The antenna 2b can also transmit a radio-frequency signal received from the radio-frequency circuit 1 to the outside.

The RFIC 3 is an example of a signal processing circuit that processes a radio-frequency signal. The RFIC 3 will be explained below more specifically. The RFIC 3 can perform signal processing, such as down-conversion, on a radio-frequency reception signal, which is received via a receive path of the radio-frequency circuit 1, and output the resulting reception signal to the BBIC 4. The RFIC 3 can also perform signal processing, such as up-conversion, on a transmission signal received from the BBIC 4 and output the resulting radio-frequency transmission signal to a transmit path of the radio-frequency circuit 1. The RFIC 3 includes a controller that controls elements, such as switches and amplifiers, of the radio-frequency circuit 1. All or some of the functions of the RFIC 3 as the controller may be implemented in a source outside the RFIC 3, such as in the BBIC 4 or the radio-frequency circuit 1.

The BBIC 4 is a baseband signal processing circuit that performs signal processing by using an intermediate-frequency band, which is lower than a radio-frequency signal transferred by the radio-frequency circuit 1. Examples of signals to be processed by the BBIC 4 are image signals for displaying images and/or audio signals for performing communication via a speaker.

The circuit configuration of the communication device 5 shown in FIG. 1 is an example and does not limit the circuit configuration of the communication device 5. In one example, the provision of the antennas 2a and 2b may be omitted. The provision of the BBIC 4 for the communication device 5 may be omitted. In another example, the communication device 5 may include three or more antennas.

### [1.2 Circuit Configuration of Radio-Frequency Circuit 1]

The circuit configuration of the radio-frequency circuit 1 included in the communication device 5 will be explained below with reference to FIG. 1. As illustrated in FIG. 1, the radio-frequency circuit 1 includes a first transfer circuit 6, a second transfer circuit 7, antenna connection terminals 101 and 102, output terminals 103 through 105, and an input terminal 106.

The antenna connection terminal 101 is an example of a first antenna connection terminal. The antenna connection terminal 101 is connected inside the radio-frequency circuit 1 to the first transfer circuit 6 and is connected outside the radio-frequency circuit 1 to the antenna 2a. With this configuration, a cellular receive band reception signal and a satellite receive band reception signal received by the antenna 2a are transferred to the first transfer circuit 6 via the antenna connection terminal 101.

The antenna connection terminal 102 is an example of a second antenna connection terminal. The antenna connection terminal 102 is connected inside the radio-frequency circuit 1 to the second transfer circuit 7 and is connected outside the radio-frequency circuit 1 to the antenna 2b. With this configuration, a cellular receive band reception signal received by the antenna 2b is transferred to the second transfer circuit 7 via the antenna connection terminal 102. Additionally, a cellular transmit band transmission signal amplified in the second transfer circuit 7 is output to the antenna 2b via the antenna connection terminal 102.

Each of the output terminals 103 through 105 is a radio-frequency output terminal for supplying a radio-frequency signal to the RFIC 3. The output terminals 103 through 105 will be explained more specifically. The output terminal 103 is connected inside the radio-frequency circuit 1 to an output terminal of the first transfer circuit 6. A cellular receive band reception signal is supplied to the RFIC 3 via the output terminal 103. The output terminal 104 is connected inside the radio-frequency circuit 1 to an output terminal of the first transfer circuit 6. A satellite receive band reception signal is supplied to the RFIC 3 via the output terminal 104. The output terminal 105 is connected inside the radio-frequency circuit 1 to the output terminal of the second transfer circuit 7. A cellular receive band reception signal is supplied to the RFIC 3 via the output terminal 105.

The input terminal 106 is a radio-frequency input terminal for receiving a radio-frequency signal from the RFIC 3. More specifically, the input terminal 106 is connected inside the radio-frequency circuit 1 to the input terminal of the second transfer circuit 7. A cellular transmit band transmission signal received from the RFIC 3 via the input terminal 106 is supplied to the second transfer circuit 7.

The first transfer circuit 6 supports the reception of the cellular communication system and the reception of the satellite system. The first transfer circuit 6 has two receive paths through which reception signals input via the antenna connection terminal 101 are transferred, but does not have a transmit path through which a transmission signal to be output via the antenna connection terminal 101 is transferred. Each of the two receive paths includes a receive filter having a pass band including the corresponding receive band. More specifically, as shown in FIG. 1, one of the two receive paths includes a filter 311 and the other one includes a filter 312. The filters 311 and 312 will be discussed later. As illustrated in FIG. 1, the first transfer circuit 6 includes a low-noise amplifier circuit 21 and a filter circuit 31.

The low-noise amplifier circuit 21 is an example of a first low-noise amplifier circuit and is connected between the filter circuit 31 and the output terminals 103 and 104 of the radio-frequency circuit 1. As shown in FIG. 1, the low-noise amplifier circuit 21 includes low-noise amplifiers 211 and 212.

The input terminal of the low-noise amplifier 211 is connected to the filter 311 in the filter circuit 31, which will be discussed later. The output terminal of the low-noise amplifier 211 is connected to the output terminal 103 of the radio-frequency circuit 1. With this configuration, the low-noise amplifier 211 can amplify a cellular receive band reception signal received via the filter 311 and supply the amplified cellular receive band reception signal to the RFIC 3 via the output terminal 103.

The input terminal of the low-noise amplifier 212 is connected to the filter 312 in the filter circuit 31, which will be discussed later. The output terminal of the low-noise amplifier 212 is connected to the output terminal 104 of the radio-frequency circuit 1. With this configuration, the low-noise amplifier 212 can amplify a satellite receive band reception signal received via the filter 312 and supply the amplified satellite receive band reception signal to the RFIC 3 via the output terminal 104.

The circuit configuration of the low-noise amplifier circuit 21 is not limited to that shown in FIG. 1. The low-noise amplifier circuit 21 may include only one low-noise amplifier. In this case, the low-noise amplifier circuit 21 may include a switch that selectively connects the input terminal of this low-noise amplifier to one of the filters 311 and 312 and include a switch that selectively connects the output terminal of this low-noise amplifier to one of the output terminals 103 and 104 of the radio-frequency circuit 1.

The filter circuit 31 is an example of a first filter circuit and is connected between the antenna connection terminal 101 and the low-noise amplifier circuit 21. As illustrated in FIG. 1, the filter circuit 31 includes filters 311 and 312 and a switch 313.

The filter 311 (A-Rx) is an example of a first receive filter and has a pass band including the cellular receive band. One end of the filter 311 is connected to the antenna connection terminal 101 via the switch 313. The other end of the filter 311 is connected to the input terminal of the low-noise amplifier 211.

The filter 312 (B-Rx) is an example of a second receive filter and has a pass band including the satellite receive band. One end of the filter 312 is connected to the antenna connection terminal 101 via the switch 313. The other end of the filter 312 is connected to the input terminal of the low-noise amplifier 212.

The switch 313 is an example of a first switch and is connected between the antenna connection terminal 101 and the filters 311 and 312. More specifically, the switch 313 has terminals 313a through 313c. The terminal 313a is connected to the antenna connection terminal 101. The terminal 313b is connected to the filter 311. The terminal 313c is connected to the filter 312.

With this connection configuration, the switch 313 can connect one of the terminals 313b and 313c to the terminal 313a based on a control signal from the RFIC 3, for example. That is, the switch 313 can selectively connect the antenna connection terminal 101 to one of the filters 311 and 312.

The switch 313 is constituted by a single pole double throw (SPDT) switch circuit, for example. In this case, the connection states of the terminals 313a, 313b, and 313c in the switch 313 are as follows. The terminal 313a is configured to selectively connect to either one of the terminals 313b and 313c. The terminal 313b is configured to connect to the terminal 313a and not to connect to the terminal 313c. The terminal 313c is configured to connect to the terminal 313a and not to connect to the terminal 313b.

The second transfer circuit 7 supports the transmission and reception of the cellular communication system. The second transfer circuit 7 has one receive path and one transmit path. A reception signal input via the antenna connection terminal 102 is transferred through the receive path. A transmission signal to be output via the antenna connection terminal 102 is transferred through the transmit path. As illustrated in FIG. 1, the second transfer circuit 7 includes a power amplifier circuit 11, a low-noise amplifier circuit 22, and a filter circuit 32.

The power amplifier circuit 11 is connected between the input terminal 106 and the filter circuit 32. As shown in FIG. 1, the power amplifier circuit 11 includes a power amplifier 111. The input terminal of the power amplifier 111 is connected to the input terminal 106. The output terminal of the power amplifier 111 is connected to a filter 321 in the filter circuit 32, which will be discussed later. With this configuration, the power amplifier 111 can amplify a cellular transmit band transmission signal received from the RFIC 3 via the input terminal 106 and output the amplified cellular transmit band transmission signal to the antenna 2b via the filter 321.

The low-noise amplifier circuit 22 is an example of a second low-noise amplifier circuit and is connected between the filter circuit 32 and the output terminal 105 of the radio-frequency circuit 1. The low-noise amplifier circuit 22 includes a low-noise amplifier 221. The input terminal of the low-noise amplifier 221 is connected to a filter 322 in the filter circuit 32, which will be discussed later. The output terminal of the low-noise amplifier 221 is connected to the output terminal 105 of the radio-frequency circuit 1. With this configuration, the low-noise amplifier 221 can amplify a cellular receive band reception signal received via the filter 322 and supply the amplified cellular receive band reception signal to the RFIC 3 via the output terminal 105.

The filter circuit 32 is an example of a second filter circuit and is connected between the antenna connection terminal 102 and each of the power amplifier circuit 11 and the low-noise amplifier circuit 22. As illustrated in FIG. 1, the filter circuit 32 includes filters 321 and 322.

The filter 321 (A-Tx) is an example of a first transmit filter and has a pass band including the cellular transmit band. One end of the filter 321 is connected to the antenna connection terminal 102. The other end of the filter 321 is connected to the output terminal of the power amplifier 111.

The filter 322 (A-Rx) is an example of a fourth receive filter and has a pass band including the cellular receive band. One end of the filter 322 is connected to the antenna connection terminal 102. The other end of the filter 322 is connected to the input terminal of the low-noise amplifier 221.

The circuit configuration of the radio-frequency circuit 1 shown in FIG. 1 is an example and does not limit the circuit configuration of the radio-frequency circuit 1. For example, the first transfer circuit 6 may also include a transmit path. Even in this case, the first transfer circuit 6 has more receive paths than the transmit path.

### [1.3 Specific Examples of Frequency Band]

Specific examples of the cellular transmit band, the cellular receive band, and the satellite receive band in the first embodiment will be described below.

In the first embodiment, as the cellular transmit band and the cellular receive band, the uplink operating band and the downlink operating band included in the same FDD band are used. As the FDD band, a frequency band in a range of 1.4 to 5 GHz can be used. More specifically, as the FDD band, for example, Band 1, Band 2, Band 3, Band 4, Band 7, Band 11, Band 21, Band 24, Band 25, Band 66, or Band 74 for LTE, or n1, n2, n3, n7, n24, n25, n66, n74, n201, n255, or n256 for 5GNR, or a desirable combination thereof may be used.

In the first embodiment, as the satellite receive band, a frequency band for receiving a signal from an artificial satellite can be used. More specifically, as the satellite receive band, for example, L1 band (1563 to 1587 MHz) for GPS, L1 band (1593 to 1610 MHz) or L5 band (1164 to 1189 MHz) for GLONASS (Global Navigation Satellite System), downlink operating band (2483.5 to 2500 MHz) for Globalstar, or n201 downlink operating band (2483.5 to 2495 MHz), n255 downlink operating band (1525 to 1559 MHz), or n256 downlink operating band (2170 to 2200 MHz) for 5GNR, or a desirable combination thereof may be used.

For example, as a combination of the cellular transmit band, cellular receive band, and satellite receive band, a combination of the uplink operating band (1626.5 to 1660.5 MHz) and the downlink operating band (1525 to 1559 MHz) of LTE Band 24 and L1 band for GPS can be used. Instead of LTE Band 24, n24 (uplink operating band: 1626.5 to 1660.5 MHz, downlink operating band: 1525 to 1559 MHz), n201 (uplink operating band: 1610 to 1626.5 MHz, downlink operating band: 2483.5 to 2495 MHz), or n255 (uplink operating band: 1626.5 to 1660.5 MHz, downlink operating band: 1525 to 1559 MHz) for 5GNR may be used, and instead of GPS L1 band, GLONASS L1 band may be used. In these combinations, the satellite receive band is included in a frequency gap (1559 to 1626.5 MHz for Band 24, for example) between the cellular transmit band and the cellular receive band.

### [1.4 First Example of Radio-Frequency Circuit 1]

As a first example of the radio-frequency circuit 1 according to the first embodiment, radio-frequency modules 1001 and 1002 including the radio-frequency circuit 1 will be described below. In the first example, the radio-frequency circuit 1 is distributed over the radio-frequency modules 1001 and 1002. More specifically, the first transfer circuit 6 is included in the radio-frequency module 1001, while the second transfer circuit 7 is included in the radio-frequency module 1002.

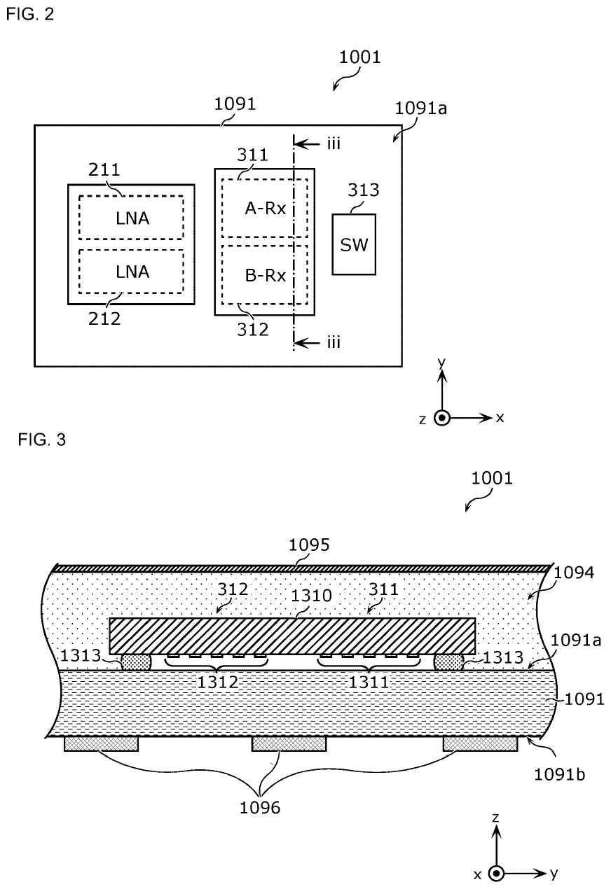

The radio-frequency module 1001 will first be discussed below with reference to FIGS. 2 and 3. FIG. 2 is a plan view of the radio-frequency module 1001 according to the first example. FIG. 3 is a partial sectional view of the radio-frequency module 1001 of the first example taken along line iii-iii in FIG. 2.

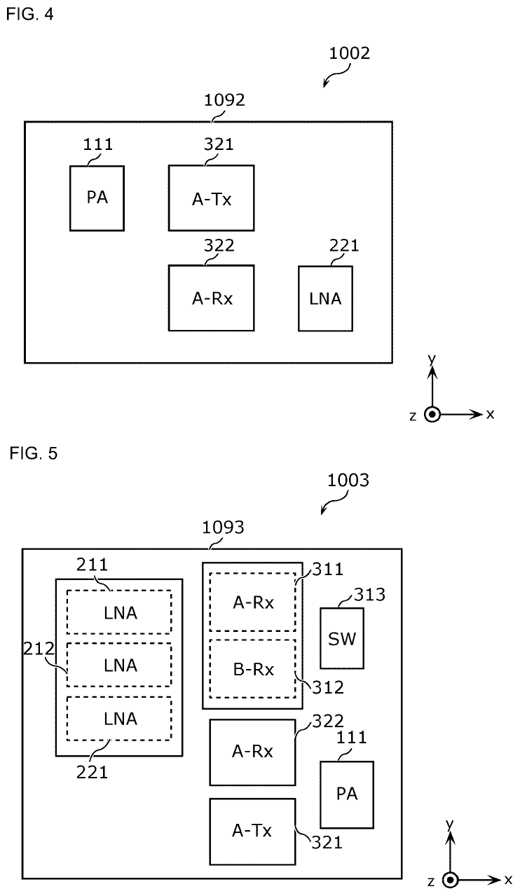

In FIGS. 2 through 4, wiring for connecting multiple circuit components is not shown. In FIGS. 2 and 4, a shield electrode layer that shields a resin member which covers the multiple circuit components and the surface of this resin member is not shown. In FIGS. 2 and 4, for easy understanding of the positional relationships between the circuit components, each component is appended with alphabetical characters representing a circuit mounted in or on the corresponding circuit component (“LNA”, for example). However, such alphabetical characters may be omitted from the actual circuit components.

The radio-frequency module 1001 is a module known as a diversity module. The radio-frequency module 1001 includes a module laminate 1091, a resin member 1094, a shield electrode layer 1095, and plural land electrodes 1096, as well as multiple circuit components having multiple circuit elements included in the low-noise amplifier circuit 21 and the filter circuit 31 shown in FIG. 1.

The module laminate 1091 is an example of a first module laminate and has main surfaces 1091a and 1091b facing each other. In FIG. 2, the module laminate 1091 has a rectangular shape in a plan view, but it is not limited to this shape.

As the module laminate 1091, a low temperature co-fired ceramics (LTCC) substrate or a high temperature co-fired ceramics (HTCC) substrate having a multilayer structure constituted by plural dielectric layers, a component-embedded board, a substrate having a redistribution layer (RDL), or a printed circuit board, for example, may be used. However, the module laminate 1091 is not limited to these examples.

On the main surface 1091a of the module laminate 1091, the low-noise amplifiers 211 and 212 (LNAs), filter 311 (A-Rx), filter 312 (B-Rx), and switch 313 (SW) are disposed. On the main surface 1091b of the module laminate 1091, the plural land electrodes 1096 are disposed.

The low-noise amplifiers 211 and 212 are included in one integrated circuit, while the switch 313 is included in another integrated circuit. The integrated circuit including the low-noise amplifiers 211 and 212 and the integrated circuit including the switch 313 may be constituted by a CMOS (Complementary Metal Oxide Semiconductor), for example, and more specifically, they may be manufactured by a SOI (Silicon on Insulator) process. The integrated circuits are not limited to a CMOS. The low-noise amplifiers 211 and 212 and the switch 313 may be included in one integrated circuit or may be separately included in three integrated circuits.

The filters 311 and 312 are constituted by surface acoustic wave (SAW) filters and are mounted in or on the same piezoelectric substrate 1310. More specifically, as shown in FIG. 3, filter components including the filters 311 and 312 are provided with the piezoelectric substrate 1310, interdigital transducer (IDT) electrodes 1311 and 1312, plural bump electrodes 1313.

The piezoelectric substrate 1310 includes a surface on which an acoustic wave propagates. In the first embodiment, the surface on which an acoustic wave propagates faces the main surface 1091a of the module laminate 1091. The piezoelectric substrate 1310 is made of LiNbO₃ single crystal or LiTaO₃ single crystal, for example.

The IDT electrodes 1311 and 1312 are disposed on the surface of the piezoelectric substrate 1310. Each of the IDT electrodes 1311 and 1312 is an example of a function electrode and can convert an acoustic wave propagating on the surface of the piezoelectric substrate 1310 into an electric signal or covert an electric signal into an acoustic wave. With the above-described configuration, the filters 311 and 312 are mounted in or on the piezoelectric substrate 1310. Each of the IDT electrodes 1311 and 1312 is made of copper, aluminum, platinum, a multilayer body thereof, or an alloy thereof.

The IDT electrodes 1311 and 1312 may be covered with a protection film. The protection film has a function of protecting the IDT electrodes 1311 and 1312 and adjusting the frequency-temperature characteristics. The protection film is made of silicon dioxide, for example.

The plural bump electrodes 1313 protrude from the surface of the piezoelectric substrate 1310, and the forward ends thereof are physically connected to the main surface 1091a of the module laminate 1091. At least some of the bump electrodes 1313 are electrically connected to the IDT electrodes 1311 and 1312. Electric signals converted by the IDT electrodes 1311 and 1312 are obtained via such bump electrodes 1313, or electric signals are supplied to the IDT electrodes 1311 and 1312 via such bump electrodes 1313. The bump electrodes 1313 are made of a highly conductive metal, such as a solder made of tin, silver, and copper or a metal having gold as a primary component.

Instead of being mounted in or on the same piezoelectric substrate, the filters 311 and 312 may be mounted in or on different piezoelectric substrates. Instead of SAW filters, the filters 311 and 312 may be constituted by another type of filter, such as bulk acoustic wave (BAW) filters. In this case, two BAW filters forming the filters 311 and 312 may be mounted in or on the same piezoelectric substrate. The filters 311 and 312 may be constituted by LC resonance filters or dielectric filters. The filters 311 and 312 may be constituted by another type of filter.

The plural land electrodes 1096 serve as plural external connection terminals including the antenna connection terminal 101 and the output terminals 103 and 104 shown in FIG. 1 and ground terminals. The land electrodes 1096 are connected to terminals, such as an input/output terminal and/or a ground terminal on a mother substrate located on the radio-frequency module 1001 in the negative direction of the z axis. Instead of the land electrodes 1096, plural bump electrodes may be disposed on the main surface 1091b.

The resin member 1094 covers the main surface 1091a and at least some of the plural circuit components on the main surface 1091a. The resin member 1094 has a function of securing the reliability, such as the mechanical strength and the moisture resistance, of circuit components on the main surface 1091a. The provision of the resin member 1094 for the radio-frequency module 1001 may be omitted.

The shield electrode layer 1095 is a metal thin film formed by sputtering, for example. The shield electrode layer 1095 is formed to cover surfaces (top surface and side surfaces) of the resin member 1094. The shield electrode layer 1095 is connected to a ground and makes it less likely for outcoming noise to enter the electronic components forming the radio-frequency module 1001 or noise produced in the radio-frequency module 1001 to interfere with another module or another device. The provision of the shield electrode layer 1095 for the radio-frequency module 1001 may be omitted.

The radio-frequency module 1002 will now be explained below with reference to FIG. 4. FIG. 4 is a plan view of the radio-frequency module 1002 according to the first example.

The radio-frequency module 1002 is a module known as a primary module. The radio-frequency module 1002 includes a module laminate 1092, a resin member (not shown), a shield electrode layer (not shown), and plural land electrodes (not shown), as well as multiple circuit components having multiple circuit elements included in the power amplifier circuit 11, the low-noise amplifier circuit 22, and the filter circuit 32 shown in FIG. 1.

The module laminate 1092 is an example of a second module laminate and has main surfaces facing each other. In FIG. 4, the module laminate 1092 has a rectangular shape in a plan view, but it is not limited to this shape. The module laminate 1092 can be configured similarly to the module laminate 1091.

On the main surface of the module laminate 1092, the power amplifier 111 (PA), low-noise amplifier 221 (LNA), filter 321 (A-Tx), and filter 322 (A-Rx) are disposed.

The power amplifier 111 is included in one integrated circuit. The integrated circuit including the power amplifier 111 may be made of at least one of gallium arsenide (GaAs), silicon germanium (SiGe), and gallium nitride (GaN). With this configuration, the power amplifier 111 having a high quality can be formed. Part of the power amplifier 111 may be constituted by a CMOS, and more specifically, it may be manufactured by a SOI process.

The low-noise amplifier 221 is similar to the low-noise amplifiers 211 and 212, and an explanation thereof will thus be omitted. The filters 321 and 322 are similar to the filters 311 and 312, except that they are mounted in or on different piezoelectric substrates, and an explanation thereof will thus be omitted.

Assuming the first transfer circuit 6 includes a transmit path, a power amplifier circuit connected to this transmit path may be included in the module laminate 1091 or in the module laminate 1902.

### [1.5 Second Example of Radio-Frequency Circuit 1]

As a second example of the radio-frequency circuit 1 according to the first embodiment, a radio-frequency module 1003 including the radio-frequency circuit 1 will be described below. In the second example, the first transfer circuit 6 and the second transfer circuit 7 included in the radio-frequency circuit 1 is mounted in or on the single radio-frequency module 1003.

The radio-frequency module 1003 will be explained below with reference to FIG. 5. FIG. 5 is a plan view of the radio-frequency module 1003 according to the second example.

In FIG. 5, wiring for connecting plural circuit components is not shown. In FIG. 5, a shield electrode layer that shields a resin member which covers the plural circuit components and the surface of this resin member is not shown. In FIG. 5, for easy understanding of the positional relationships between the circuit components, each component is appended with alphabetical characters representing a circuit mounted in or on the corresponding circuit component (“LNA”, for example). However, such alphabetical characters may be omitted from the actual circuit components.

A module laminate 1093 has main surfaces facing each other. In FIG. 5, the module laminate 1093 has a rectangular shape in a plan view, but it is not limited to this shape. The module laminate 1093 can be configured similarly to the module laminate 1091.

On the main surface of the module laminate 1093, the power amplifier 111, low-noise amplifiers 211, 212, and 221, filters 311, 312, 321, and 322, and switch 313 are disposed.

### [1.6 Advantages and Others]

As described above, a radio-frequency circuit 1 according to the first embodiment includes a first transfer circuit 6 and a second transfer circuit 7. The first transfer circuit 6 supports the reception of a cellular communication system and the reception of a satellite system. The second transfer circuit 7 supports the transmission and reception of the cellular communication system. The first transfer circuit 6 includes a filter circuit 31 and a low-noise amplifier circuit 21. The filter circuit 31 is connected to an antenna connection terminal 101 and has a pass band including a cellular receive band and a satellite receive band. The low-noise amplifier circuit 21 is connected to the filter circuit 31. The second transfer circuit 7 includes a filter circuit 32, a power amplifier circuit 11, and a low-noise amplifier circuit 22. The filter circuit 32 is connected to an antenna connection terminal 102 and has a pass band including the cellular receive band and a cellular transmit band corresponding to the cellular receive band. The power amplifier circuit 11 is connected to the filter circuit 32. The low-noise amplifier circuit 22 is connected to the filter circuit 32.

With the above-described configuration, the filter circuit 31 having a pass band including a cellular receive band and a satellite receive band is connected to the antenna connection terminal 101. Hence, the same antenna can be used for the cellular receive band and the satellite receive band. This makes it easy to mount a circuit for the cellular receive band and a circuit for the satellite receive band in or on one module laminate 1091 or 1093, thereby contributing to reducing the size of the communication device 5. The filter circuit 31 for the satellite receive band is connected to the antenna connection terminal 101, which is different from the antenna connection terminal 102 to which the filter circuit 32 for the cellular transmit band is connected. This can reduce the interference of a cellular transmission signal with a satellite reception signal, thereby making it less likely to degrade the reception sensitivity in the satellite system.

In one example, in the radio-frequency circuit 1 according to the first embodiment, the first transfer circuit 6 may include one or more receive paths through which a reception signal input via the antenna connection terminal 101 is transferred. It is not essential that the first transfer circuit 6 includes a transmit path through which a transmission signal to be output via the antenna connection terminal 101 is transferred.

With this configuration, no transmit path is included in the first transfer circuit 6 that supports the reception of the satellite system, thereby improving the reception sensitivity of the satellite system. The first transfer circuit 6 is applicable to, for example, a receive circuit (diversity module) for receiving a signal using a diversity antenna.

In another example, in the radio-frequency circuit 1 according to the first embodiment, the filter circuit 31 may include a switch 313 and filters 311 and 312. The switch 313 is connected to the antenna connection terminal 101. The filter 311 is connected to the antenna connection terminal 101 via the switch 313 and has a pass band including the cellular receive band. The filter 312 is connected to the antenna connection terminal 101 via the switch 313 and has a pass band including the satellite receive band.

With this configuration, the filter 311 supporting the cellular receive band and the filter 312 supporting the satellite receive band are separately included in the radio-frequency circuit 1. This can enhance isolation between the receive path for the cellular receive band and the receive path for the satellite receive band.

In another example, in the radio-frequency circuit 1 according to the first embodiment, each of the filters 311 and 312 may be an acoustic wave filter. The filters 311 and 312 may be mounted in or on the same identical piezoelectric substrate, such as a piezoelectric substrate 1310.

With this configuration, the filters 311 and 312 are mounted in or on the same piezoelectric substrate, thereby making it possible to reduce the size of the radio-frequency circuit 1. This can contribute to reducing the size of the communication device 5.

In another example, in the radio-frequency circuit 1 according to the first embodiment, the cellular transmit band and the cellular receive band may be an uplink operating band and a downlink operating band included in the same FDD band.

With this configuration, the radio-frequency circuit 1 can be used for the transmission and reception of the FDD band.

In another example, in the radio-frequency circuit 1 according to the first embodiment, the satellite receive band may be included in a gap between the cellular transmit band and the cellular receive band.

With this configuration, the radio-frequency circuit 1 can be used assuming the satellite receive band is close to the cellular transmit band and the cellular receive band. The degradation of the reception sensitivity in the satellite system can be suppressed more effectively.

In another example, in the radio-frequency circuit 1 according to the first embodiment, the filter circuit 32 may include filters 321 and 322. The filter 321 is connected to the second antenna connection terminal 102 and has a pass band including the cellular transmit band. The filter 322 is connected to the second antenna connection terminal 102 and has a pass band including the cellular receive band. The power amplifier circuit 11 may be connected to the filter 321. The low-noise amplifier circuit 22 may be connected to the filter 322.

With this configuration, a duplexer can be used for the cellular transmit band and the cellular receive band.

In another example, the radio-frequency circuit 1 according to the first embodiment may further include module laminates 1091 and 1092. In or on the module laminate 1091, the filter circuit 31 and the low-noise amplifier circuit 21 are mounted. In or on the module laminate 1092, the filter circuit 32, the power amplifier circuit 11, and the low-noise amplifier circuit 22 are mounted.

With this configuration, the isolation between the filter circuit 31 and the low-noise amplifier circuit 21 connected to an antenna 2a via the antenna connection terminal 101 and the filter circuit 32, the power amplifier circuit 11, and the low-noise amplifier circuit 22 connected to an antenna 2b via the antenna connection terminal 102 can be enhanced. This can make it less likely to degrade the reception sensitivity in the satellite system.

In another example, the radio-frequency circuit 1 according to the first embodiment may further include a module laminate 1093 in or on which the filter circuits 31 and 32, the power amplifier circuit 11, the low-noise amplifier circuits 21 and 22 are mounted.

This enables the radio-frequency circuit 1 to contribute to further reducing the size of the communication device 5.

### Second Embodiment

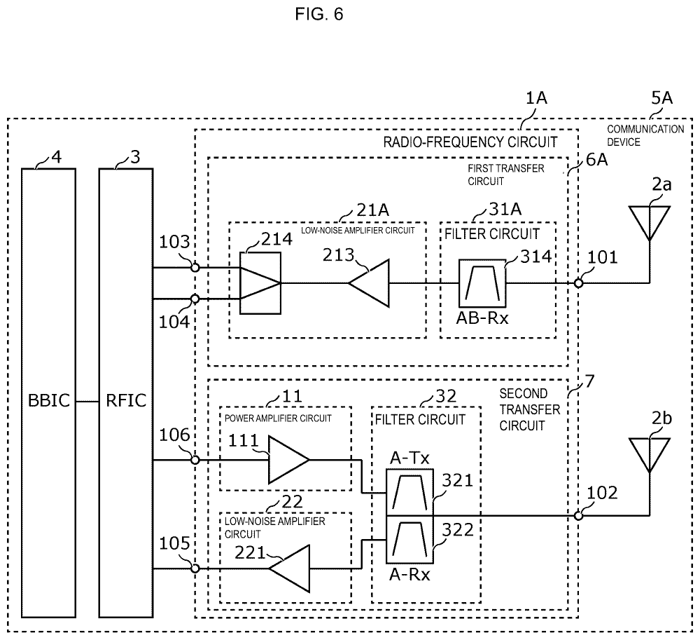

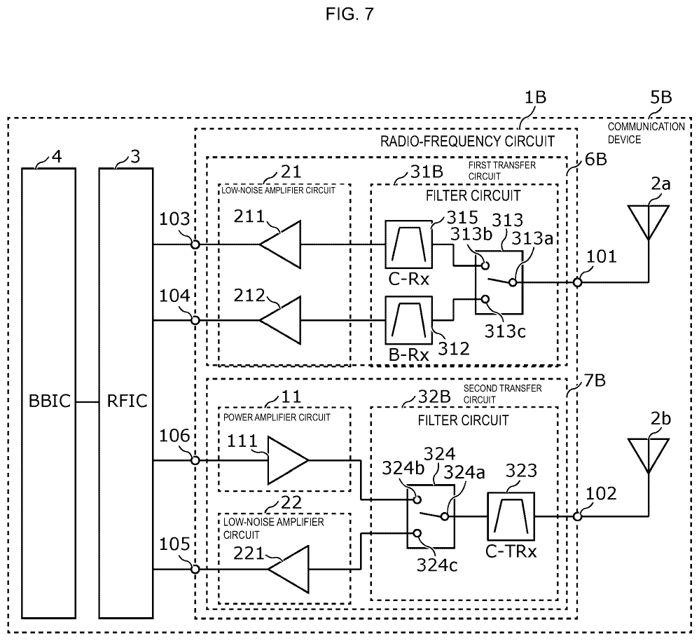

A second embodiment will be described below. The second embodiment is different from the first embodiment mainly in that diversity reception is implemented with one filter having a pass band including the cellular receive band and the satellite receive band. The second embodiment will be described below with reference to FIG. 6 mainly by referring to the points different from the first embodiment.

### [2.1 Circuit Configuration of Radio-Frequency Circuit 1A]

The circuit configuration of a communication device 5A according to the second embodiment is similar to that of the communication device 5 of the first embodiment, except that the communication device 5A includes a radio-frequency circuit 1A instead of the radio-frequency circuit 1. A detailed explanation of the communication device 5A will thus be omitted, and the radio-frequency circuit 1A will be explained below with reference to FIG. 6.

FIG. 6 is a circuit diagram of the communication device 5A according to the second embodiment. As illustrated in FIG. 6, the radio-frequency circuit 1A includes a first transfer circuit 6A, a second transfer circuit 7, antenna connection terminals 101 and 102, output terminals 103 through 105, and an input terminal 106.

The first transfer circuit 6A includes a low-noise amplifier circuit 21A and a filter circuit 31A.

The low-noise amplifier circuit 21A is an example of the first low-noise amplifier circuit and is connected between the filter circuit 31A and the output terminals 103 and 104 of the radio-frequency circuit 1A. As illustrated in FIG. 1, the low-noise amplifier circuit 21A includes a low-noise amplifier 213 and a splitter 214.

The input terminal of the low-noise amplifier 213 is connected to a filter 314 in the filter circuit 31A, which will be discussed later. The output terminal of the low-noise amplifier 213 is connected to the output terminals 103 and 104 of the radio-frequency circuit 1A via the splitter 214. With this configuration, the low-noise amplifier 213 can amplify reception signals of band A and band B received via the filter 314 and supply the amplified reception signals of band A and band B to the RFIC 3 via the output terminals 103 and 104.

The splitter 214 is an example of a power divider and is connected between the low-noise amplifier 213 and the output terminals 103 and 104 of the radio-frequency circuit 1A. The input terminal of the splitter 214 is connected to the output terminal of the low-noise amplifier 213. Two output terminals of the splitter 214 are connected to the corresponding output terminals 103 and 104 of the radio-frequency circuit 1A. With this configuration, the splitter 214 can distribute an output signal of the low-noise amplifier 213 over the two output terminals 103 and 104.

The filter circuit 31A is an example of the first filter circuit and is connected between the antenna connection terminal 101 and the low-noise amplifier circuit 21A. As shown in FIG. 1, the filter circuit 31A includes a filter 314.

The filter 314 (AB-Rx) is an example of a third receive filter and has a pass band including the cellular receive band and the satellite receive band. One end of the filter 314 is connected to the antenna connection terminal 101. The other end of the filter 314 is connected to the input terminal of the low-noise amplifier 213.

### [2.2 Specific Examples of Frequency Band]

Specific examples of the cellular transmit band, the cellular receive band, and the satellite receive band in the second embodiment will be described below.

In the second embodiment, as a combination of the cellular transmit band, cellular receive band, and satellite receive band, a combination of the uplink operating band and the downlink operating band of LTE Band 24 and GPS L1 band can be used. Instead of LTE Band 24, 5GNR n24, n201, or n255 may be used, and instead of GPS L1 band, GLONASS L1 band may be used.

### [2.3 Advantages and Others]

As described above, a radio-frequency circuit 1A according to the second embodiment includes a first transfer circuit 6A and a second transfer circuit 7. The first transfer circuit 6A supports the reception of a cellular communication system and the reception of a satellite system. The second transfer circuit 7 supports the transmission and reception of the cellular communication system. The first transfer circuit 6A includes a filter circuit 31A and a low-noise amplifier circuit 21A. The filter circuit 31A is connected to an antenna connection terminal 101 and has a pass band including a cellular receive band and a satellite receive band. The low-noise amplifier circuit 21A is connected to the filter circuit 31A. The second transfer circuit 7 includes a filter circuit 32, a power amplifier circuit 11, and a low-noise amplifier circuit 22. The filter circuit 32 is connected to an antenna connection terminal 102 and has a pass band including the cellular receive band and a cellular transmit band corresponding to the cellular receive band. The power amplifier circuit 11 is connected to the filter circuit 32. The low-noise amplifier circuit 22 is connected to the filter circuit 32.

With the above-described configuration, the filter circuit 31A having a pass band including a cellular receive band and a satellite receive band is connected to the antenna connection terminal 101. Hence, the same antenna can be used for the cellular receive band and the satellite receive band. This makes it easy to mount a circuit for the cellular receive band and a circuit for the satellite receive band in or on one module laminate 1091 or 1093, thereby contributing to reducing the size of the communication device 5A. The filter circuit 31A for the satellite receive band is connected to the antenna connection terminal 101, which is different from the antenna connection terminal 102 to which the filter circuit 32 for the cellular transmit band is connected. This can reduce the interference of a cellular transmission signal with a satellite reception signal, thereby making it less likely to degrade the reception sensitivity in the satellite system.

In one example, in the radio-frequency circuit 1A according to the second embodiment, the first transfer circuit 6A may include one or more receive paths through which a reception signal input via the antenna connection terminal 101 is transferred. It is not essential that the first transfer circuit 6A includes a transmit path through which a transmission signal to be output via the antenna connection terminal 101 is transferred.

With this configuration, no transmit path is included in the first transfer circuit 6A that supports the reception of the satellite system, thereby improving the reception sensitivity of the satellite system. The first transfer circuit 6A is applicable to, for example, a receive circuit (diversity module) for receiving a signal using a diversity antenna.

In another example, in the radio-frequency circuit 1A according to the second embodiment, the filter circuit 31A may include a filter 314 having a pass band including the cellular receive band and the satellite receive band.

With this configuration, the number of filters used for the radio-frequency circuit 1A becomes fewer than that assuming the radio-frequency circuit 1A includes individual filters for the cellular receive band and the satellite receive band. The radio-frequency circuit 1A can thus contribute to reducing the size of the communication device 5A.

In another example, in the radio-frequency circuit 1A according to the second embodiment, the low-noise amplifier circuit 21A may include a low-noise amplifier 213 and a splitter 214. The low-noise amplifier 213 is connected to the filter 314. The splitter 214 is connected to the output terminal of the low-noise amplifier 213.

With this configuration, even though the filter 314 is used for both of the cellular receive band and the satellite receive band, the radio-frequency circuit 1A can supply a cellular receive band reception signal and a satellite receive band reception signal to the RFIC 3 via the two output terminals 103 and 104.

In another example, in the radio-frequency circuit 1A according to the second embodiment, as a combination of the cellular receive band and the satellite receive band, a combination of the downlink operating band of Band 24 for LTE or the downlink operating band of n24, n201, or n255 for 5GNR and L1 band for GPS or GLONASS may be used.

With this configuration, as a combination of the cellular receive band and the satellite receive band, a combination of two receive bands relatively close to each other can be used. The performance requirements for the filter 314 and the low-noise amplifier 213 can thus become less demanding.

### Third Embodiment

A third embodiment will be described below. The third embodiment is different from the first embodiment mainly in that the same frequency band included in the TDD (Time Division Duplex) band is used as the cellular transmit band and the cellular receive band. The third embodiment will be described below with reference to FIG. 7 mainly by referring to the points different from the first embodiment.

### [3.1 Circuit Configuration of Radio-Frequency Circuit 1B]

The circuit configuration of a communication device 5B according to the third embodiment is similar to that of the communication device 5 of the first embodiment, except that the communication device 5B includes a radio-frequency circuit 1B instead of the radio-frequency circuit 1. A detailed explanation of the communication device 5B will thus be omitted, and the radio-frequency circuit 1B will be explained below with reference to FIG. 7.

FIG. 7 is a circuit diagram of the communication device 5B according to the third embodiment. As illustrated in FIG. 7, the radio-frequency circuit 1B includes a first transfer circuit 6B, a second transfer circuit 7B, antenna connection terminals 101 and 102, output terminals 103 through 105, and an input terminal 106.

The first transfer circuit 6B includes a low-noise amplifier circuit 21 and a filter circuit 31B.

The filter circuit 31B is an example of the first filter circuit and is connected between the antenna connection terminal 101 and the low-noise amplifier circuit 21. As illustrated in FIG. 7, the filter circuit 31B is similar to the filter circuit 31, except that it includes a filter 315 (C-Rx) instead of the filter 311 (A-Rx).

The filter 315 (C-Rx) is an example of the first receive filter and has a pass band including the cellular receive band (that is, TDD band). One end of the filter 315 is connected to the antenna connection terminal 101 via the switch 313. The other end of the filter 315 is connected to the input terminal of the low-noise amplifier 211.

The second transfer circuit 7B includes a power amplifier circuit 11, a low-noise amplifier circuit 22, and a filter circuit 32B.

The filter circuit 32B is an example of the second filter circuit and is connected between the antenna connection terminal 102 and each of the power amplifier circuit 11 and the low-noise amplifier circuit 22. As illustrated in FIG. 7, the filter circuit 32B includes a filter 323 and a switch 324.

The filter 323 (C-TRx) is an example of a transmit/receive filter and has a pass band including the cellular transmit band and the cellular receive band (that is, TDD band). One end of the filter 323 is connected to the antenna connection terminal 102. The other end of the filter 323 is connected to the output terminal of the power amplifier 111 and the input terminal of the low-noise amplifier 221 via the switch 324.

The switch 324 is an example of a second switch and is connected between the filter 323 and each of the power amplifier circuit 11 and the low-noise amplifier circuit 22. More specifically, the switch 324 has terminals 324a through 324c. The terminal 324a is connected to the filter 323. The terminal 324b is connected to the output terminal of the power amplifier 111. The terminal 324c is connected to the input terminal of the low-noise amplifier 221.

With this connection configuration, the switch 324 can connect one of the terminals 324b and 324c to the terminal 324a based on a control signal from the RFIC 3, for example. That is, the switch 324 can selectively connect the filter 323 to one of the power amplifier circuit 11 and the low-noise amplifier circuit 22.

The switch 324 is constituted by an SPDT switch circuit, for example. In this case, the connection states of the terminals 324a, 324b, and 324c in the switch 324 are as follows. The terminal 324a is configured to selectively connect to either one of the terminals 324b and 324c. The terminal 324b is configured to connect to the terminal 324a and not to connect to the terminal 324c. The terminal 324c is configured to connect to the terminal 324a and not to connect to the terminal 324b.

### [3.2 Specific Examples of Frequency Band]

Specific examples of the cellular transmit band, the cellular receive band, and the satellite receive band in the third embodiment will be described below.

In the third embodiment, the same frequency band included in the same TDD band is used as the cellular transmit band and the cellular receive band. As the TDD band, the frequency band of 1.4 to 5 GHz may be used. More specifically, as the TDD band, for example, Band 34, Band 39, Band 40, Band 41, Band 42, or Band 48 for LTE, or n34, n39, n40, n41, n48, n77, n78, or n79 for 5GNR, or a desirable combination thereof may be used.

In the third embodiment, as the satellite receive band, the frequency band for receiving a signal from an artificial satellite can be used. More specifically, as the satellite receive band, for example, L1 band or L5 band for GPS, L1 band for GLONASS, the downlink operating band for Globalstar, the downlink operating band of n201, n255, or n256 for 5GNR, or a desirable combination thereof may be used.

### [3.3 Advantages and Others]

As described above, a radio-frequency circuit 1B according to the third embodiment includes a first transfer circuit 6B and a second transfer circuit 7B. The first transfer circuit 6B supports the reception of a cellular communication system and the reception of a satellite system. The second transfer circuit 7B supports the transmission and reception of the cellular communication system. The first transfer circuit 6B includes a filter circuit 31B and a low-noise amplifier circuit 21. The filter circuit 31B is connected to an antenna connection terminal 101 and has a pass band including a cellular receive band and a satellite receive band. The low-noise amplifier circuit 21 is connected to the filter circuit 31B. The second transfer circuit 7B includes a filter circuit 32B, a power amplifier circuit 11, and a low-noise amplifier circuit 22. The filter circuit 32B is connected to an antenna connection terminal 102 and has a pass band including the cellular receive band and a cellular transmit band corresponding to the cellular receive band. The power amplifier circuit 11 is connected to the filter circuit 32B. The low-noise amplifier circuit 22 is connected to the filter circuit 32B.

With the above-described configuration, the filter circuit 31B having a pass band including a cellular receive band and a satellite receive band is connected to the antenna connection terminal 101. Hence, the same antenna can be used for the cellular receive band and the satellite receive band. This makes it easy to mount a circuit for the cellular receive band and a circuit for the satellite receive band in or on one module laminate 1091 or 1093, thereby contributing to reducing the size of the communication device 5B. The filter circuit 31B for the satellite receive band is connected to the antenna connection terminal 101, which is different from the antenna connection terminal 102 to which the filter circuit 32B for the cellular transmit band is connected. This can reduce the interference of a cellular transmission signal with a satellite reception signal, thereby making it less likely to degrade the reception sensitivity in the satellite system.

In one example, in the radio-frequency circuit 1B according to the third embodiment, the first transfer circuit 6B may include one or more receive paths through which a reception signal input via the antenna connection terminal 101 is transferred. It is not essential that the first transfer circuit 6B includes a transmit path through which a transmission signal to be output via the antenna connection terminal 101 is transferred.

With this configuration, no transmit path is included in the first transfer circuit 6B that supports the reception of the satellite system, thereby improving the reception sensitivity of the satellite system. The first transfer circuit 6B is applicable to, for example, a receive circuit (diversity module) for receiving a signal using a diversity antenna.

In another example, in the radio-frequency circuit 1B according to the third embodiment, the cellular transmit band and the cellular receive band may be the same frequency band included in the same TDD band.

With this configuration, the radio-frequency circuit 1B can be used for the transmission and reception of the TDD band.

In another example, in the radio-frequency circuit 1B according to the third embodiment, the filter circuit 32B may include a filter 323 having a pass band including the TDD band and a switch 324 connected to the filter 323. The power amplifier circuit 11 may be connected to the filter 323 via the switch 324. The low-noise amplifier circuit 22 may be connected to the filter 323 via the switch 324.

With this configuration, the number of filters used for the radio-frequency circuit 1B becomes fewer than that assuming the radio-frequency circuit 1B includes individual filters for the cellular transmit band and the cellular receive band.

### Modified Example of Third Embodiment

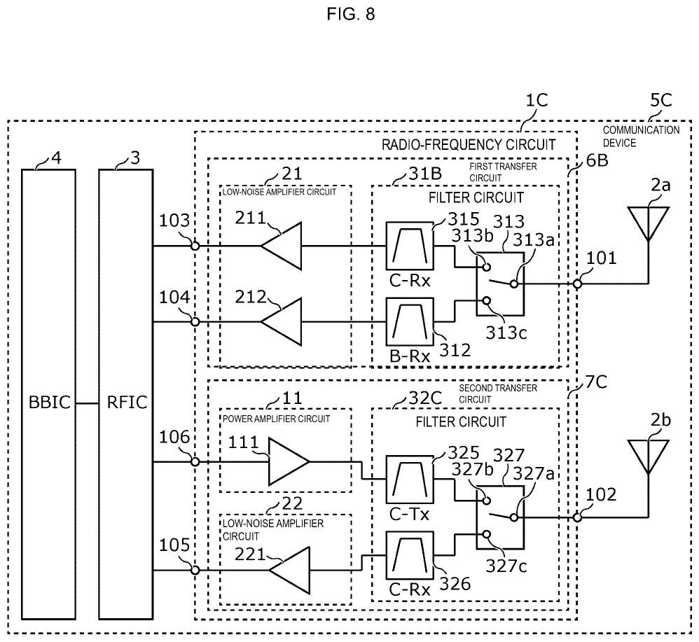

A modified example of the third embodiment will now be described below. In the modified example, as well as in the third embodiment, the same frequency band included in the same TDD band is used as the cellular transmit band and the cellular receive band. The modified example is different from the third embodiment mainly in that a radio-frequency circuit includes a filter for the transmission of the TDD band and a filter for the reception of the TDD band. The modified example will be described below with reference to FIG. 8 mainly by referring to the points different from the third embodiment.

The circuit configuration of a communication device 5C according to the modified example is similar to that of the communication device 5 of the first embodiment, except that the communication device 5C includes a radio-frequency circuit 1C instead of the radio-frequency circuit 1. A detailed explanation of the communication device 5C will thus be omitted, and the radio-frequency circuit 1C will be explained below with reference to FIG. 8.

FIG. 8 is a circuit diagram of the communication device 5C according to the modified example of the third embodiment. As illustrated in FIG. 8, the radio-frequency circuit 1C includes a first transfer circuit 6B, a second transfer circuit 7C, antenna connection terminals 101 and 102, output terminals 103 through 105, and an input terminal 106.

The second transfer circuit 7C includes a power amplifier circuit 11, a low-noise amplifier circuit 22, and a filter circuit 32C.

The filter circuit 32C is an example of the second filter circuit and is connected between the antenna connection terminal 102 and each of the power amplifier circuit 11 and the low-noise amplifier circuit 22. As illustrated in FIG. 8, the filter circuit 32C includes filters 325 and 326 and a switch 327.

The filter 325 (C-Tx) is an example of a second transmit filter and has a pass band including the cellular transmit band (that is, TDD band). One end of the filter 325 is connected to the antenna connection terminal 102 via the switch 327. The other end of the filter 325 is connected to the output terminal of the power amplifier 111.

The filter 326 (C-Rx) is an example of a fifth receive filter and has a pass band including the cellular receive band (that is, TDD band). One end of the filter 326 is connected to the antenna connection terminal 102 via the switch 327. The other end of the filter 326 is connected to the input terminal of the low-noise amplifier 221.

The switch 327 is an example of a third switch and is connected between the antenna connection terminal 102 and the filters 325 and 326. More specifically, the switch 327 has terminals 327a through 327c. The terminal 327a is connected to the antenna connection terminal 102. The terminal 327b is connected to the filter 325. The terminal 327c is connected to the filter 326.

With this connection configuration, the switch 327 can connect one of the terminals 327b and 327c to the terminal 327a based on a control signal from the RFIC 3, for example. That is, the switch 327 can selectively connect the antenna connection terminal 102 to one of the filters 325 and 326.

The switch 327 is constituted by an SPDT switch circuit, for example. In this case, the connection states of the terminals 327a, 327b, and 327c in the switch 327 are as follows. The terminal 327a is configured to selectively connect to either one of the terminals 327b and 327c. The terminal 327b is configured to connect to the terminal 327a and not to connect to the terminal 327c. The terminal 327c is configured to connect to the terminal 327a and not to connect to the terminal 327b.

As described above, in a radio-frequency circuit 1C according to the modified example of the third embodiment, the filter circuit 32C may include a switch 327 and filters 325 and 326. The switch 327 is connected to the antenna connection terminal 102. The filter 325 is connected to the antenna connection terminal 102 via the switch 327 and has a pass band including the TDD band. The filter 326 is connected to the antenna connection terminal 102 via the switch 327 and has a pass band including the TDD band. The power amplifier circuit 11 may be connected to the filter 325. The low-noise amplifier circuit 22 may be connected to the filter 326.

With this configuration, the filter 325 suitable for the transmission of the TDD band and the filter 326 suitable for the reception of the TDD band can be used.

Both in the third embodiment and the modified example, the filters 312 and 315 and the switch 313 of the filter circuit 31B may be replaced by a single filter, such as the filter 314 used in the second embodiment. In this case, as a combination of the cellular transmit band and the cellular receive band (that is, TDD band) and the satellite receive band, Band 41 (2496 to 2690 MHz) for LTE and the downlink operating band of Globalstar or the downlink operating band of n201 for 5GNR may be used. LTE Band 41 may be replaced by 5GNR n41 (2496 to 2690 MHz).

In this manner, as a combination of the cellular receive band and the satellite receive band, LTE Band 41 or 5GNR n41 and the downlink operating band for Globalstar can be used.

As the cellular receive band and the satellite receive band, a combination of two receive bands relatively close to each other can be used. The performance requirements for the filter 314 and the low-noise amplifier 213 can thus become less demanding.

### Fourth Embodiment

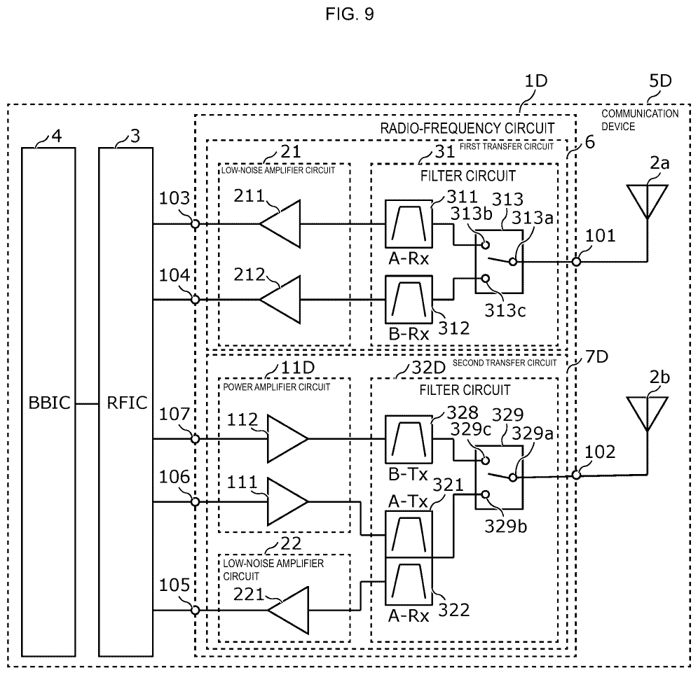

A fourth embodiment will be described below. The fourth embodiment is different from the first embodiment mainly in that a communication device supports, not only satellite reception, but also satellite transmission. The fourth embodiment will be described below with reference to FIG. 9 mainly by referring to the points different from the first embodiment.

### [4.1 Circuit Configuration of Radio-Frequency Circuit 1D]

The circuit configuration of a communication device 5D according to the fourth embodiment is similar to that of the communication device 5 of the first embodiment, except that the communication device 5D includes a radio-frequency circuit 1D instead of the radio-frequency circuit 1. A detailed explanation of the communication device 5D will thus be omitted, and the radio-frequency circuit 1D will be explained below with reference to FIG. 9.

FIG. 9 is a circuit diagram of the communication device 5D according to the fourth embodiment. As illustrated in FIG. 9, the radio-frequency circuit 1D includes a first transfer circuit 6, a second transfer circuit 7D, antenna connection terminals 101 and 102, output terminals 103 through 105, and input terminals 106 and 107.

The input terminal 107 is a radio-frequency input terminal for receiving a radio-frequency signal from the RFIC 3. More specifically, the input terminal 107 is connected inside the radio-frequency circuit 1 to the input terminal of a power amplifier circuit 11D. A satellite transmit band transmission signal received from the RFIC 3 via the input terminal 107 is supplied to the power amplifier circuit 11D.

The second transfer circuit 7D includes a power amplifier circuit 11D, a low-noise amplifier circuit 22, and a filter circuit 32D.

The power amplifier circuit 11D is connected between the input terminals 106 and 107 and the filter circuit 32D. As shown in FIG. 9, the power amplifier circuit 11D includes power amplifiers 111 and 112.

The input terminal of the power amplifier 112 is connected to the input terminal 107. The output terminal of the power amplifier 112 is connected to a filter 328 in the filter circuit 32D, which will be discussed later. With this configuration, the power amplifier 112 can amplify a satellite transmit band transmission signal received from the RFIC 3 via the input terminal 107 and output the amplified satellite transmit band transmission signal to the antenna 2b via the filter 328.

The circuit configuration of the power amplifier circuit 11D is not limited to that shown in FIG. 9. The power amplifier circuit 11D may include only one power amplifier. In this case, the power amplifier circuit 11D may include a switch that selectively connects the output terminal of this power amplifier to one of the filters 321 and 328 and may include a switch that selectively connects the input terminal of this power amplifier to one of the input terminals 106 and 107 of the radio-frequency circuit 1D.

The filter circuit 32D is an example of the second filter circuit and is connected between the antenna connection terminal 102 and each of the power amplifier circuit 11D and the low-noise amplifier circuit 22. As illustrated in FIG. 9, the filter circuit 32D includes filters 321, 322, and 328 and a switch 329.

The filter 328 (B-Tx) is an example of a third transmit filter and has a pass band including the satellite transmit band. One end of the filter 328 is connected to the antenna connection terminal 102 via the switch 329. The other end of the filter 328 is connected to the output terminal of the power amplifier 112.

The switch 329 is connected between the antenna connection terminal 102 and the filters 321, 322, and 328. More specifically, the switch 329 has terminals 329a through 329c. The terminal 329a is connected to the antenna connection terminal 102. The terminal 329b is connected to the filters 321 and 322. The terminal 329c is connected to the filter 328.

With this connection configuration, the switch 329 can connect one of the terminals 329b and 329c to the terminal 329a based on a control signal from the RFIC 3, for example. That is, the switch 329 can selectively connect the antenna connection terminal 102 to the filter 328 or a set of the filters 321 and 322.

The switch 329 is constituted by an SPDT switch circuit, for example. In this case, the connection states of the terminals 329a, 329b, and 329c in the switch 329 are as follows. The terminal 329a is configured to selectively connect to either one of the terminals 329b and 329c. The terminal 329b is configured to connect to the terminal 329a and not to connect to the terminal 329c. The terminal 329c is configured to connect to the terminal 329a and not to connect to the terminal 329b.

### [4.2 Specific Examples of Frequency Band]

Specific examples of the cellular transmit band, the cellular receive band, the satellite transmit band, and the satellite receive band in the fourth embodiment will be described below.

In the fourth embodiment, the uplink operating band and the downlink operating band included in the same FDD band are used as the cellular transmit band and the cellular receive band. More specifically, the cellular transmit band and the cellular receive band similar to those in the first embodiment.

In the fourth embodiment, as the satellite transmit band and the satellite receive band, the uplink operating band and the downlink operating band for the satellite communication system can be used. More specifically, as the satellite transmit band and the satellite receive band, for example, the uplink operating band (1610 to 1621.35 MHz) and the downlink operating band for Globalstar or the uplink operating band and the downlink operating band of n201, n255 or n256 for 5GNR may be used.

### [4.3 Advantages and Others]

As described above, a radio-frequency circuit 1D according to the fourth embodiment includes a first transfer circuit 6 and a second transfer circuit 7D. The first transfer circuit 6 supports the reception of a cellular communication system and the reception of a satellite system. The second transfer circuit 7D supports the transmission and reception of the cellular communication system. The first transfer circuit 6 includes a filter circuit 31 and a low-noise amplifier circuit 21. The filter circuit 31 is connected to an antenna connection terminal 101 and has a pass band including a cellular receive band and a satellite receive band. The low-noise amplifier circuit 21 is connected to the filter circuit 31. The second transfer circuit 7D includes a filter circuit 32D, a power amplifier circuit 11D, and a low-noise amplifier circuit 22. The filter circuit 32D is connected to an antenna connection terminal 102 and has a pass band including the cellular receive band and a cellular transmit band corresponding to the cellular receive band. The power amplifier circuit 11D is connected to the filter circuit 32D. The low-noise amplifier circuit 22 is connected to the filter circuit 32D.

With the above-described configuration, the filter circuit 31 having a pass band including a cellular receive band and a satellite receive band is connected to the antenna connection terminal 101. Hence, the same antenna can be used for the cellular receive band and the satellite receive band. This makes it easy to mount a circuit for the cellular receive band and a circuit for the satellite receive band in or on one module laminate 1091 or 1093, thereby contributing to reducing the size of the communication device 5D. The filter circuit 31 for the satellite receive band is connected to the antenna connection terminal 101, which is different from the antenna connection terminal 102 to which the filter circuit 32D for the cellular transmit band is connected. This can reduce the interference of a cellular transmission signal with a satellite reception signal, thereby making it less likely to degrade the reception sensitivity in the satellite system.

In one example, in the radio-frequency circuit 1D according to the fourth embodiment, the filter circuit 32D may include a filter 328 having a pass band including a satellite transmit band corresponding to the satellite receive band. The power amplifier circuit 11D may be connected to the filter 328.

With this configuration, the same antenna can be used for the cellular transmit band and the satellite transmit band, thereby contributing to reducing the size of the communication device 5D.

In the fourth embodiment, the low-noise amplifier circuit 21 and the filter circuit 31 may be replaced by the low-noise amplifier circuit 21A and the filter circuit 31A used in the second embodiment. In the fourth embodiment, the same frequency band included in the same TDD band may be used as the cellular transmit band and the cellular receive band, as in the third embodiment or the modified example thereof. In this case, instead of the filters 321 and 322, the filter circuit 32D may include the filter 323 and the switch 324 or the filters 325 and 326.

### Fifth Embodiment

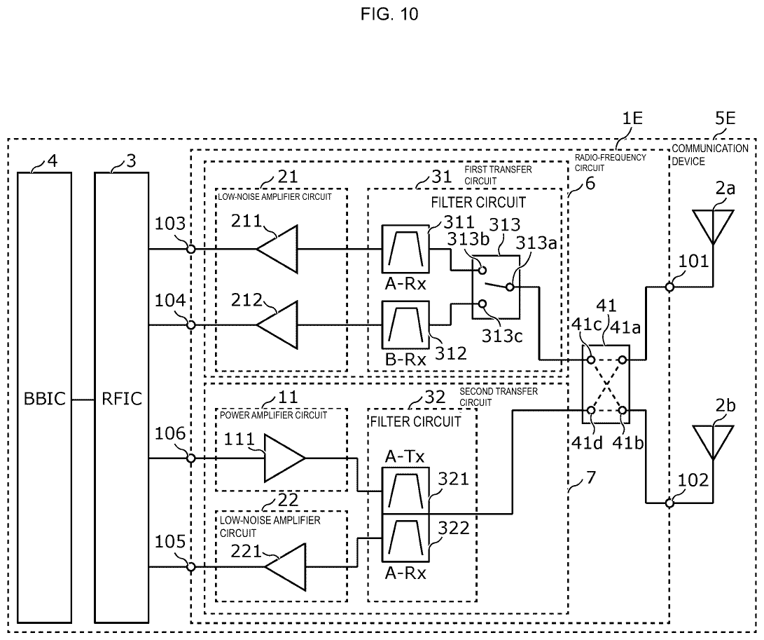

A fifth embodiment will be described below. The fifth embodiment is different from the first embodiment mainly in that a radio-frequency circuit includes a switch for switching between two antenna connection terminals and between two filter circuits. The fifth embodiment will be described below with reference to FIG. 10 mainly by referring to the points different from the first embodiment.

### [5.1 Circuit Configuration of Radio-Frequency Circuit 1E]

The circuit configuration of a communication device 5E according to the fifth embodiment is similar to that of the communication device 5 of the first embodiment, except that the communication device 5E includes a radio-frequency circuit 1E instead of the radio-frequency circuit 1. A detailed explanation of the communication device 5E will thus be omitted, and the radio-frequency circuit 1E will be explained below with reference to FIG. 10.

FIG. 10 is a circuit diagram of the communication device 5E according to the fifth embodiment. As illustrated in FIG. 10, the radio-frequency circuit 1E includes a power amplifier circuit 11, low-noise amplifier circuits 21 and 22, filter circuits 31 and 32, a switch circuit 41, antenna connection terminals 101 and 102, output terminals 103 through 105, and an input terminal 106.

The switch circuit 41 is connected between the antenna connection terminals 101 and 102 and the filter circuits 31 and 32. More specifically, the switch circuit 41 has terminals 41a through 41d. The terminal 41a is connected to the antenna connection terminal 101. The terminal 41b is connected to the antenna connection terminal 102. The terminal 41c is connected to the filter circuit 31. The terminal 41d is connected to the filter circuit 32.

With this connection configuration, based on a control signal from the RFIC 3, for example, the switch circuit 41 can connect the terminal 41a to one of the terminals 41c and 41d and the terminal 41b to the other one of the terminals 41c and 41d. That is, the switch circuit 41 can selectively connect the antenna connection terminal 101 to one of the filter circuits 31 and 32 and the antenna connection terminal 102 to the other one of the filter circuits 31 and 32.

The switch circuit 41 is constituted by a double pole double throw (DPDT) switch circuit, for example. In this case, the connection states of the terminals 41a through 41d in the switch circuit 41 are as follows. The terminal 41a is configured to selectively connect to either one of the terminals 41c and 41d and not to connect to the terminal 41b. The terminal 41b is configured to selectively connect to either one of the terminals 41c and 41d and not to connect to the terminal 41a. The terminal 41c is configured to selectively connect to either one of the terminals 41a and 41b and not to connect to the terminal 41d. The terminal 41d is configured to selectively connect to either one of the terminals 41a and 41b and not to connect to the terminal 41c.

### [5.2 Advantages and Others]

As described above, a radio-frequency circuit 1E according to the fifth embodiment includes a first transfer circuit 6 and a second transfer circuit 7. The first transfer circuit 6 supports the reception of a cellular communication system and the reception of a satellite system. The second transfer circuit 7 supports the transmission and reception of the cellular communication system. The first transfer circuit 6 includes a filter circuit 31 and a low-noise amplifier circuit 21. The filter circuit 31 is connected to an antenna connection terminal 101 and has a pass band including a cellular receive band and a satellite receive band. The low-noise amplifier circuit 21 is connected to the filter circuit 31. The second transfer circuit 7 includes a filter circuit 32, a power amplifier circuit 11, and a low-noise amplifier circuit 22. The filter circuit 32 is connected to an antenna connection terminal 102 and has a pass band including the cellular receive band and a cellular transmit band corresponding to the cellular receive band. The power amplifier circuit 11 is connected to the filter circuit 32. The low-noise amplifier circuit 22 is connected to the filter circuit 32.

With the above-described configuration, the filter circuit 31 having a pass band including a cellular receive band and a satellite receive band is connected to the antenna connection terminal 101. Hence, the same antenna can be used for the cellular receive band and the satellite receive band. This makes it easy to mount a circuit for the cellular receive band and a circuit for the satellite receive band in or on one module laminate 1091 or 1093, thereby contributing to reducing the size of the communication device 5E. The filter circuit 31 for the satellite receive band is connected to the antenna connection terminal 101, which is different from the antenna connection terminal 102 to which the filter circuit 32 for the cellular transmit band is connected. This can reduce the interference of a cellular transmission signal with a satellite reception signal, thereby making it less likely to degrade the reception sensitivity in the satellite system.

In one example, the radio-frequency circuit 1E according to the fifth embodiment may further include a switch circuit 41. The switch circuit 41 includes a terminal 41a connected to the antenna connection terminal 101, a terminal 41b connected to the antenna connection terminal 102, a terminal 41c connected to the filter circuit 31, and a terminal 41d connected to the filter circuit 32.

With this configuration, it is possible to switch between the antenna used for the transmission and reception of the cellular communication system and the antenna used for the reception of the cellular communication system and the satellite system. This can improve the quality of a transmission signal and enhance the reception sensitivity.

In the fifth embodiment, the switch circuit 41 is included in the radio-frequency circuit 1 of the first embodiment. However, this is only an example. The switch circuit 41 may be included in the radio-frequency circuits 1A through 1D of the second through fourth embodiments.

The switch circuit 41 may be disposed outside the radio-frequency circuits 1A through 1E of the communication devices 5A through 5E. In this case, the switch circuit 41 may be connected between the antennas 2a and 2b and the radio-frequency circuit 1. More specifically, the terminals 41a and 41b of the switch circuit 41 may be connected to the antennas 2a and 2b, and the terminals 41c and 41d of the switch circuit 41 may be connected to the antenna connection terminals 101 and 102. Such a switch circuit 41 may be mounted on a mother substrate.

### Other Embodiments

A radio-frequency circuit and a communication device according to an embodiment of the present disclosure have been discussed above through illustration of the embodiments. However, a radio-frequency circuit according to an embodiment of the disclosure is not restricted to the above-described embodiments. Other embodiments implemented by combining certain elements in the above-described embodiments and modified examples obtained by making various modifications to the above-described embodiments by those skilled in the art without departing from the scope and spirit of the disclosure are also encompassed in the disclosure. Various types of equipment integrating the above-described radio-frequency circuits are also encompassed in the disclosure.

In one example, in the circuit configurations of the radio-frequency circuits according to the above-described embodiments, another circuit element and another wiring may be inserted onto a path connecting circuit elements and/or onto a path connecting signal paths illustrated in the drawings. For instance, in each of the above-described embodiments, an impedance matching circuit may be inserted between a low-noise amplifier circuit and a filter circuit and/or between a power amplifier circuit and a filter circuit.

In another example, in the radio-frequency circuit according to each of the above-described embodiments, the first transfer circuit does not include any transmit path, but may include one or more transmit paths. That is, in the radio-frequency circuit according to each of the above-described embodiments, the first transfer circuit may include one or more receive paths through which a reception signal input via the antenna connection terminal 101 is transferred, and one or more transmit paths through which a transmission signal to be output via the antenna connection terminal 101 is transferred. The one or more receive paths may each include one receive filter having a pass band including a receive band. The one or more transmit paths may each include one transmit filter having a pass band including a transmit band. The number of the one or more receive paths may be greater than the number of the one or more transmit paths.

With this configuration, the number of transmit paths included in the first transfer circuit supporting the reception of the satellite system can be reduced, thereby improving the reception sensitivity of the satellite system. The first transfer circuit is applicable to, for example, a receive circuit (diversity module) for receiving a signal using a diversity antenna.

In some of the above-described embodiments, such as in the first embodiment, the uplink operating band is used as the cellular transmit band, while the downlink operating band is used as the cellular receive band. However, this is only an example. For instance, assuming the communication device is used as a base station, the downlink operating band may be used as the cellular transmit band, while the uplink operating band may be used as the cellular receive band.

The present disclosure can be used widely in communication equipment, such as mobile phones, as a radio-frequency circuit disposed in a front-end section.

What is claimed is:

1. A radio-frequency circuit comprising:
a first transfer circuit that supports reception of a cellular communication system and reception of a satellite system; and
a second transfer circuit that supports transmission and reception of the cellular communication system,
the first transfer circuit including
a first filter circuit that is connected to a first antenna connection terminal and has a pass band including a cellular receive band and a satellite receive band, and
a first low-noise amplifier circuit connected to the first filter circuit,
the second transfer circuit including
a second filter circuit that is connected to a second antenna connection terminal and has a pass band including the cellular receive band and a cellular transmit band corresponding to the cellular receive band,
a power amplifier circuit connected to the second filter circuit, and
a second low-noise amplifier circuit connected to the second filter circuit,
wherein the first transfer circuit includes one or more receive paths through which a reception signal input via the first antenna connection terminal is transferred, and the first transfer circuit does not include a transmit path through which a transmission signal to be output via the first antenna connection terminal is transferred.

2. The radio-frequency circuit according to claim 1, wherein:
the first transfer circuit further includes
one or more transmit paths through which a transmission signal to be output via the first antenna connection terminal is transferred;
the one or more receive paths each include one receive filter having a pass band including a receive band;
the one or more transmit paths each include one transmit filter having a pass band including a transmit band; and
the number of the one or more receive paths is greater than the number of the one or more transmit paths.

3. The radio-frequency circuit according to claim 1, wherein the first filter circuit includes
a first switch connected to the first antenna connection terminal,
a first receive filter that is connected to the first antenna connection terminal via the first switch and has a pass band including the cellular receive band, and
a second receive filter that is connected to the first antenna connection terminal via the first switch and has a pass band including the satellite receive band.

4. The radio-frequency circuit according to claim 3, wherein:
each of the first receive filter and the second receive filter is an acoustic wave filter; and
the first receive filter and the second receive filter are mounted in or on an identical piezoelectric substrate.

5. The radio-frequency circuit according to claim 1, wherein the first filter circuit includes a third receive filter having a pass band including the cellular receive band and the satellite receive band.

6. The radio-frequency circuit according to claim 5, wherein the first low-noise amplifier circuit includes
a low-noise amplifier connected to the third receive filter, and
a power divider connected to an output terminal of the low-noise amplifier.

7. The radio-frequency circuit according to claim 5, wherein a combination of the cellular receive band and the satellite receive band is a combination of a downlink operating band of Band 24 for LTE (Long Term Evolution) or a downlink operating band of n24, n201, or n255 for 5GNR (5th Generation New Radio) and L1 band for GPS (Global Positioning System) or GLONASS (Global Navigation Satellite System) or is a combination of Band 41 for LTE or n41 for 5GNR and a downlink operating band of Globalstar or a downlink operating band of n201 for 5GNR.

8. The radio-frequency circuit according to claim 1, wherein the cellular transmit band and the cellular receive band are an uplink operating band and a downlink operating band included in an identical frequency division duplex band.

9. The radio-frequency circuit according to claim 8, wherein the satellite receive band is included in a gap between the cellular transmit band and the cellular receive band.

10. The radio-frequency circuit according to claim 8, wherein:
the second filter circuit includes
a first transmit filter that is connected to the second antenna connection terminal and has a pass band including the cellular transmit band, and
a fourth receive filter that is connected to the second antenna connection terminal and has a pass band including the cellular receive band;
the power amplifier circuit is connected to the first transmit filter; and
the second low-noise amplifier circuit is connected to the fourth receive filter.

11. The radio-frequency circuit according to claim 1, wherein the cellular transmit band and the cellular receive band are an identical frequency band included in an identical time division duplex band.

12. The radio-frequency circuit according to claim 11, wherein:
the second filter circuit includes
a transmit/receive filter having a pass band including the time division duplex band, and
a second switch connected to the transmit/receive filter;
the power amplifier circuit is connected to the transmit/receive filter via the second switch; and
the second low-noise amplifier circuit is connected to the transmit/receive filter via the second switch.

13. The radio-frequency circuit according to claim 11, wherein:
the second filter circuit includes
a third switch connected to the second antenna connection terminal,
a second transmit filter connected to the second antenna connection terminal via the third switch and has a pass band including the time division duplex band, and
a fifth receive filter connected to the second antenna connection terminal via the third switch and has a pass band including the time division duplex band;
the power amplifier circuit is connected to the second transmit filter; and
the second low-noise amplifier circuit is connected to the fifth receive filter.

14. The radio-frequency circuit according to claim 10, wherein:
the second transfer circuit also supports transmission of the satellite system;
the second filter circuit further includes a third transmit filter having a pass band including a satellite transmit band corresponding to the satellite receive band; and
the power amplifier circuit is also connected to the third transmit filter.

15. The radio-frequency circuit according to claim 1, further comprising:
a switch circuit including a terminal connected to the first antenna connection terminal, a terminal connected to the second antenna connection terminal, a terminal connected to the first filter circuit, and a terminal connected to the second filter circuit.

16. The radio-frequency circuit according to claim 1, further comprising:
a first module laminate in or on which the first filter circuit and the first low-noise amplifier circuit are mounted; and
a second module laminate in or on which the second filter circuit, the power amplifier circuit, and the second low-noise amplifier circuit are mounted.

17. The radio-frequency circuit according to claim 1, further comprising:
a module laminate in or on which the first filter circuit, the second filter circuit, the power amplifier circuit, the first low-noise amplifier circuit, and the second low-noise amplifier circuit are mounted.

18. The radio-frequency circuit according to claim 1, further comprising:
a first module laminate in or on which the first filter circuit and the first low-noise amplifier circuit are mounted.

19. The radio-frequency circuit according to claim 18, further comprising:
a second module laminate in or on which the second filter circuit, the power amplifier circuit, and the second low-noise amplifier circuit are mounted.

20. The radio-frequency circuit according to claim 2, wherein the cellular transmit band and the cellular receive band are an identical frequency band included in an identical time division duplex band.
